(19) United States
(12) Patent Application Publication
(10) Pub. No.: US 2018/0218191 A1
(43) Pub. Date: Aug. 2, 2018

(54) OUTSIDE OF ACTIVE AREA FINGER-PRINT SENSOR

(71) Applicant: SYNAPTICS INCORPORATED, San Jose, CA (US)

(72) Inventors: Damien BERGET, Sunnyvale, CA (US); Kasra KHAZENI, San Jose, CA (US); Prashant SHAMARAO, Cupertino, CA (US)

(21) Appl. No.: 15/420,605

(22) Filed: Jan. 31, 2017

(51) Int. Cl. G06K 9/00; G06F 3/044

(52) U.S. Cl. CPC G06K 9/0002; G06F 2203/04106; G06F 3/044; G06K 9/00087

(57) ABSTRACT

Embodiments herein describe an input device that includes a display area for outputting images which includes a capacitive sensing region. For example, the display area may include transparent sensor electrodes that can identify a location of an input object (e.g., a finger or stylus) within the sensing region. Moreover, the input device may include a fingerprint sensor disposed in a fan out region of a plurality of traces that are electrically coupled to display or capacitive sensing elements in the display area. The input device may include isolation logic disposed between the fingerprint sensor and the display area. When activated, the isolation logic electrically insulates a first portion of the traces in the fingerprint sensor from a second portion of the traces in the display area. Once disconnected, the input device can use the first portion of the traces to perform fingerprint sensing.

### FIELD OF THE INVENTION

This invention generally relates to electronic devices and performing capacitive sensing.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. In one example, the sensing region includes sensing electrodes used to measure changes in capacitance resulting from an input object (e.g., a finger or stylus) interacting with the sensing region. In addition, the input device may include a fingerprint sensor that uses capacitive sensing to detect ridges and valleys in a finger. Identifying space for both a touch sensor for detecting 2D or 3D locations of an input object and a fingerprint sensor can be challenging.

### BRIEF SUMMARY OF THE INVENTION

One embodiment described herein is an input device that includes a display region configured to display an image, a processing system, a fan out region comprising a fingerprint sensor, isolation logic, and a plurality of traces coupling the processing system to the display region where the plurality of traces extend through the fingerprint sensor and the display region. The fingerprint sensor is configured to perform capacitive sensing using the plurality of traces when the isolation logic electrically disconnects a first portion of the plurality of traces extending through the display region from a second portion of the plurality of traces extending through the fingerprint sensor.

Another embodiment described herein includes a processing system for performing capacitive sensing. The processing system includes a sensor module configured to couple to a plurality of traces where the plurality of traces extend through a fingerprint sensor in a fan out region to reach a display region. The sensor module is configured to control isolation logic to electrically disconnect a first portion of the plurality of traces extending through the display region from a second portion of the plurality of traces extending through the fingerprint sensor and perform capacitive sensing in the fingerprint sensor using the second portion of the plurality of traces when the second portion is disconnected from the first portion.

Another embodiment described herein is a method for performing capacitive sensing. The method includes electrically disconnecting a first portion of a plurality of traces extending through a display region from a second portion of the plurality of traces extending through a fingerprint sensor, wherein the plurality of traces couple a processing system to the display region via a fan out region, wherein the fan out region comprises the fingerprint sensor and performing capacitive sensing using the second portion of the plurality of traces in the fingerprint sensor when the first portion is disconnected from the second portion.

### BRIEF DESCRIPTION OF DRAWINGS

So that the manner in which the above recited features of the present invention can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an exemplary system that includes an input device in accordance with an embodiment of the invention;

FIG. 2 is input device that includes a matrix sensor arrangement in accordance with an embodiment of the invention;

FIG. 3 illustrates a fingerprint sensor in a fan out region of an input device in accordance with an embodiment of the invention;

FIG. 4 illustrates a fingerprint sensor that uses absolute capacitance in accordance with an embodiment of the invention;

FIGS. 5A and 5B illustrate operating a fingerprint sensor in accordance with an embodiment of the invention;

FIG. 6 illustrates guarding unused electrodes in a fingerprint sensor in accordance with an embodiment of the invention;

FIG. 7 illustrates a fingerprint sensor that forms a trapezoidal shape in accordance with an embodiment of the invention;

FIG. 8 illustrates a fingerprint sensor that uses transcapacitive sensing in accordance with an embodiment of the invention; and

FIG. 9 is a flow chart for operating a fingerprint sensor in accordance with an embodiment of the invention.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention provide input devices and methods that facilitate improved usability. In one embodiment, the input device includes a display region for outputting images and includes a capacitive sensing region. For example, the display region may include transparent sensor electrodes that can identify a location of an input object (e.g., a finger or stylus) within the sensing region. Moreover, the input device may include a fingerprint sensor disposed in a fan out region of a plurality of traces that are electrically coupled to display or capacitive sensing elements in the display region. For example, the traces may be display source lines for altering the colors of display pixels. Alternatively, the traces may be coupled to respective sensor electrodes in the sensing region in order to perform capacitive sensing. In another example, the traces may be common electrodes used to perform both display updating and capacitive sensing.

The input device includes isolation logic disposed between the fingerprint sensor and the display region. When activated, the isolation logic electrically insulates a first portion of the traces in the fingerprint sensor from a second portion of the traces in the display region. Once disconnected, the input device can use the first portion of the traces to perform fingerprint sensing. In one embodiment, the fingerprint sensor relies on absolute capacitive sensing to detect a fingerprint. To do so, the fingerprint sensor includes a plurality of sensor electrodes arranged in a rectangular array. The sensor may also include a plurality of gate lines that are coupled to switches (e.g., transistors) that selectively couple the traces to the sensor electrodes. In one embodiment, the input device rasters through the fingerprint sensor by using the gate lines to select which row of the sensor electrodes is coupled to the traces.

In another embodiment, the fingerprint sensor uses transcapacitive sensing to detect a fingerprint. After disconnecting the traces in the fingerprint sensor from the display region, the sensor may drive a transmitter signal using transmitter electrodes that extend in a direction perpendicular to the traces. The input device may include sensors coupled to the traces which receive resulting signals caused by the capacitive coupled between the transmitter electrodes and the traces. In this example, the traces serve as receiver electrodes for performing capacitive sensing.

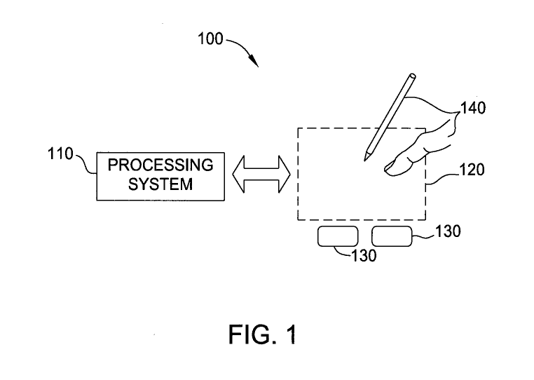

Turning now to the figures, FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1. In one embodiment, the input device 100 is a fingerprint sensor that senses the different features in a finger such as ridges and valleys which can be used to form a fingerprint. The fingerprint sensor may be a swipe sensor, where a fingerprint image is reconstructed from a series of scans as the user moves their finger over the sensor, or a placement sensor, where a sufficient area of the fingerprint can be captured from a single scan as the user holds her finger at a fixed location in the sensing region 120.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100. In another embodiment, the sensing region 120 has a circular shape that conforms to the shape of a fingertip.

The input device 100 may utilize any combination of sensor components and sensing technologies to detect user input in the sensing region 120. The input device 100 comprises one or more sensing elements for detecting user input.

Some implementations are configured to provide images that span one, two, three, or higher dimensional spaces. Some implementations are configured to provide projections of input along particular axes or planes.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (lCs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes (e.g., unlocking the user device or providing access to secure data using a detected fingerprint), as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

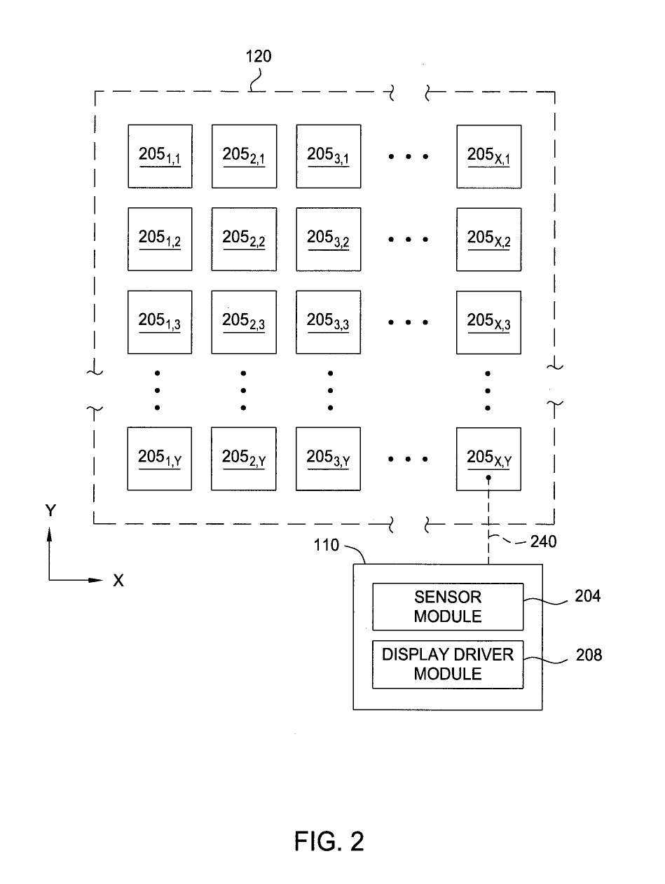

FIG. 2 shows a portion of an exemplary pattern of capacitive sensing pixels 205 (also referred to herein as capacitive pixels or sensing pixels) configured to sense in the sensing region 120 associated with a pattern, according to some embodiments. Each capacitive pixel 205 may include one of more of the sensing elements described above. For clarity of illustration and description, FIG. 2 presents the regions of the capacitive pixels 205 in a pattern of simple rectangles and does not show various other components within the capacitive pixels 205. In one embodiment, the capacitive sensing pixels 205 are areas of localized capacitance (capacitive coupling). Capacitive pixels 205 may be formed between an individual sensor electrode and ground in a first mode of operation and between groups of sensor electrodes used as transmitter and receiver electrodes in a second mode of operation. The capacitive coupling changes with the proximity and motion of input objects in the sensing region 120 associated with the capacitive pixels 205, and thus may be used as an indicator of the presence of the input object in the sensing region 120 of the input device or to detect ridges and valleys when used as a fingerprint sensor.

The exemplary pattern comprises an array of capacitive sensing pixels 205 X,Y (referred collectively as pixels 205) arranged in X columns and Y rows in a common plane, wherein X and Y are positive integers, although one of X and Y may be zero. It is contemplated that the pattern of sensing pixels 205 may comprise a plurality of sensing pixels 205 having other configurations, such as polar arrays, repeating patterns, non-repeating patterns, non-uniform array a single row or column, or other suitable arrangement. Further, as will be discussed in more detail below, the sensor electrodes in the sensing pixels 205 may be any shape such as circular, rectangular, diamond, star, square, nonconvex, convex, nonconcave, concave, etc. As shown here, the sensing pixels 205 are coupled to the processing system 110.

In a first mode of operation, at least one sensor electrode within the capacitive sensing pixels 205 may be utilized to detect the presence of an input object via absolute sensing techniques. A sensor module 204 (e.g., a sensor circuit or sensor circuitry) in processing system 110 is configured to drive a sensor electrode using a trace 240 in each pixel 205 with a capacitive sensing signal (which can be modulated or unmodulated) and measure a capacitance between the sensor electrode and the input object (e.g., free space or earth ground) based on the capacitive sensing signal, which is utilized by the processing system 110 or other processor to determine the position of the input object or features in a finger.

The various electrodes of capacitive pixels 205 are typically ohmically isolated from the electrodes of other capacitive pixels 205. Additionally, where a pixel 205 includes multiple electrodes, the electrodes may be ohmically isolated from each other. That is, one or more insulators separate the sensor electrodes and prevent them from electrically shorting to each other.

In a second mode of operation, sensor electrodes in the capacitive pixels 205 are utilized to detect the presence of an input object via transcapacitance sensing techniques. That is, processing system 110 may drive at least one sensor electrode in a pixel 205 with a transmitter signal and receive resulting signals using one or more of the other sensor electrodes in the pixel 205, where a resulting signal comprising effects corresponding to the transmitter signal. The resulting signal is utilized by the processing system 110 or other processor to determine the position of the input object.

The input device 100 may be configured to operate in any one of the modes described above. The input device 100 may also be configured to switch between any two or more of the modes described above.

In some embodiments, the capacitive pixels 205 are “scanned” to determine these capacitive couplings. That is, in one embodiment, one or more of the sensor electrodes are driven to transmit transmitter signals. Transmitters may be operated such that one transmitter electrode transmits at one time, or multiple transmitter electrodes transmit at the same time. Where multiple transmitter electrodes transmit simultaneously, the multiple transmitter electrodes may transmit the same transmitter signal and effectively produce an effectively larger transmitter electrode. Alternatively, the multiple transmitter electrodes may transmit different transmitter signals. For example, multiple transmitter electrodes may transmit different transmitter signals according to one or more coding schemes that enable their combined effects on the resulting signals of receiver electrodes to be independently determined.

The sensor electrodes configured as receiver sensor electrodes may be operated singly or multiply to acquire resulting signals. The resulting signals may be used to determine measurements of the capacitive couplings at the capacitive pixels 205.

In other embodiments, “scanning” pixels 205 to determine these capacitive coupling includes driving with a modulated signal and measuring the absolute capacitance of one or more of the sensor electrodes. In another embodiment, the sensor electrodes may be operated such that the modulated signal is driven on a sensor electrode in multiple capacitive pixels 205 at the same time. In such embodiments, an absolute capacitive measurement may be obtained from each of the one or more pixels 205 simultaneously. In one embodiment, the input device 100 simultaneously drives a sensor electrode in a plurality of capacitive pixels 205 and measures an absolute capacitive measurement for each of the pixels 205 in the same sensing cycle. In various embodiments, processing system 110 may be configured to selectively drive and receive with a portion of sensor electrodes. For example, the sensor electrodes may be selected based on, but not limited to, an application running on the host processor, a status of the input device, an operating mode of the sensing device and a determined location of an input object. In another embodiment, the input object (e.g., a finger) is the transmitter that is driven with the modulated signal while the sensor electrode is a receiver.

A set of measurements from the capacitive pixels 205 form a capacitive image (also capacitive frame) representative of the capacitive couplings at the pixels 205 as discussed above. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

In some embodiments, one or more of the sensor electrodes in the capacitive pixels 205 include one or more display electrodes used in updating the display of the display screen. In one or more embodiments, the display electrodes comprise one or more segments of a Vcom electrode (common electrodes), a source drive line, gate line, an anode electrode or cathode electrode, or any other display element. These display electrodes may be disposed on an appropriate display screen substrate. For example, the electrodes may be disposed on the transparent substrate (a glass substrate, TFT glass, a plastic substrate or any other transparent material) in some display screens (e.g., In Plane Switching (IPS) or Plane to Line Switching (PLS) Organic Light Emitting Diode (OLED)), on the bottom of the color filter glass of some display screens (e.g., Patterned Vertical Alignment (PVA) or Multi-domain Vertical Alignment (MVA)), over an emissive layer (OLED), etc. In such embodiments, an electrode that is used as both a sensor and a display electrode can also be referred to as a combination electrode, since it performs multiple functions.

Continuing to refer to FIG. 2, the processing system 110 coupled to the sensing electrodes includes a sensor module 204 and optionally, a display driver module 208. In one embodiment the sensor module comprises circuitry configured to drive a transmitter signal onto and receive resulting signals with the sensing electrodes during periods in which input sensing is desired. In one embodiment the sensor module 204 includes a transmitter module including circuitry configured to drive a transmitter signal onto the sensing electrodes during periods in which input sensing is desired. The transmitter signal is generally modulated and contains one or more bursts over a period of time allocated for input sensing. The transmitter signal may have an amplitude, frequency and voltage which may be changed to obtain more robust location information of the input object in the sensing region. The modulated signal used in absolute capacitive sensing may be the same or different from the transmitter signal used in transcapacitance sensing. The sensor module 204 may be selectively coupled to one or more of the sensor electrodes in the capacitive pixels 205. For example, the sensor module 204 may be coupled to selected portions of the sensor electrodes and operate in either an absolute or transcapacitance sensing mode. In another example, the sensor module 204 may be coupled to different sensor electrodes when operating in the absolute sensing mode than when operating in the transcapacitance sensing mode.

In various embodiments the sensor module 204 may comprise a receiver module that includes circuitry configured to receive a resulting signal with the sensing electrodes comprising effects corresponding to the transmitter signal during periods in which input sensing is desired. In one or more embodiments, the receiver module is configured to drive a modulated signal onto a first sensor electrode in one of the pixels 205 and receive a resulting signal corresponding to the modulated signal to determine changes in absolute capacitance of the sensor electrode. The receiver module may determine a position of the input object in the sensing region 120 or may provide a signal including information indicative of the resulting signal to another module or processor, for example, a determination module or a processor of the electronic device (i.e., a host processor), for determining the position of the input object in the sensing region 120. In one or more embodiments, the receiver module comprises a plurality of receivers, where each receiver may be an analog front end (AFE).

In one or more embodiments, capacitive sensing (or input sensing) and display updating may occur during at least partially overlapping periods. For example, as a combination electrode is driven for display updating, the combination electrode may also be driven for capacitive sensing. Or overlapping capacitive sensing and display updating may include modulating the reference voltage(s) of the display device and/or modulating at least one display electrode for a display in a time period that at least partially overlaps with when the sensor electrodes are configured for capacitive sensing. In another embodiment, capacitive sensing and display updating may occur during non-overlapping periods, also referred to as non-display update periods. In various embodiments, the non-display update periods may occur between display line update periods for two display lines of a display frame and may be at least as long in time as the display update period. In such embodiment, the non-display update period may be referred to as a long horizontal blanking period, long h-blanking period or a distributed blanking period. In other embodiments, the non-display update period may comprise horizontal blanking periods and vertical blanking periods. Processing system 110 may be configured to drive sensor electrodes for capacitive sensing during any one or more of or any combination of the different non-display update times.

The display driver module 208 includes circuitry confirmed to provide display image update information to the display of the display device during non-sensing (e.g., display updating) periods. The display driver module 208 may be included with or separate from the sensor module 204. In one embodiment, the processing system comprises a first integrated circuit comprising the display driver module 208 and at least a portion of the sensor module 204 (i.e., transmitter module and/or receiver module). In another embodiment, the processing system comprises a first integrated circuit comprising the display driver module 208 and a second integrated circuit comprising the sensor module 204. In yet another embodiment, the processing system comprises a first integrated circuit comprising a display driver module 208 and one of a transmitter module or a receiver module and a second integrated circuit comprising the other one of the transmitter module and receiver module.

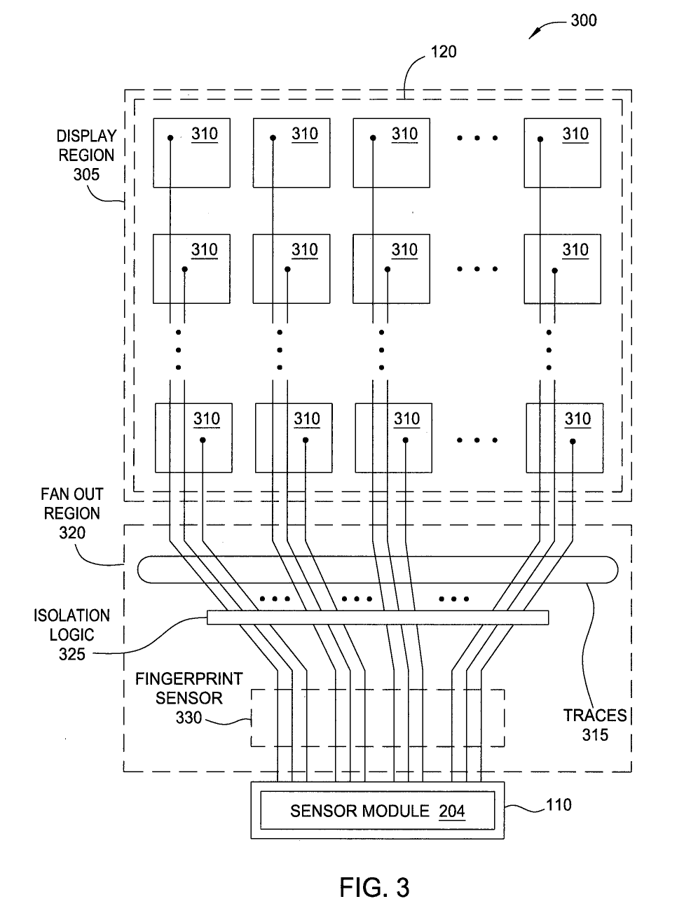

FIG. 3 illustrates a fingerprint sensor 330 in a fan out region 320 of an input device 100 in accordance with an embodiment of the invention. The input device 100 includes a display region 305 (e.g., an active area of a display) which includes display elements (e.g., pixels, subpixels, display material, electrodes, etc.) for displaying an image to a user. The display region 305 may include light emitting diodes (LED), organic LEDs (OLED), a cathode ray tube (CRT), a liquid crystal display (LCD), plasma, electroluminescence (EL), or other display technology. The display region 305 also includes the sensing region 120 which, in this example, is formed by a plurality of sensor electrodes 310 arranged in a rectangular array (e.g., a sensor electrode matrix). Each of the sensor electrodes 310 in FIG. 3 may correspond to one of the capacitive sensing pixels 205 illustrated in FIG. 2.

The sensor electrodes 310 are each coupled to a respective one of a plurality of traces 315. That is, each of the traces 315 couples to only one of the sensor electrodes 310. However, in other embodiments, a plurality of traces 315 is coupled to a respective one of the sensor electrodes 310 and are driven using the same voltages which may increase the sensing speed of the input device 100. As described above, the sensor module 204 can transmit and/or receive signals using the traces 315 in order to perform capacitive sensing using the sensor electrodes 310. To couple the sensor electrodes 310 in the display region 305 to the sensor module 204, the traces extend through a fan out region 320. In this embodiment, the processing system 110 is an integrated circuit. Because the width of the processing system 110 (e.g., the left and right dimension) is smaller than the width of the sensing region 120, the traces 320 “fan out” in the fan out region 320 when extending from the processing system 110 to the display region 305. In one embodiment, the fan out region 320 at least includes a routing space between the processing system 110 (e.g., an integrated circuit) and the bottom row of the sensor electrodes 310. Here, the fan out region 320 includes an area where the traces 315 are extending in parallel as well as an area where the separation distance between the traces 315 is increasing. As shown, the fan out region 320 is outside of the active area of the display region 305, as such, the fan out region 320 may not include any pixels or subpixels for displaying an image to the user. Thus, the fingerprint sensor 330 is disposed in a region outside of the display region 305.

In one embodiment, the fingerprint sensor 330 is disposed in any inactive region of the input device (e.g., outside of the active region of the display region 305) regardless whether the traces 315 fan out. For example, the fingerprint sensor 330 can be formed using the portion of the traces 315 outside the active region of the display even if the input device 100 does not include any region where the traces 315 fan out.

In the input device 100 in FIG. 3, the fingerprint sensor 330 is disposed in a portion of the fan out region 320 where the traces 315 extend parallel to each other. However, in other embodiments, the fingerprint sensor 330 can also include a portion of the fan out region 320 where the separation distance between the traces 315 increases as the traces 315 extend in a direction towards the display region 305. Regardless of the location of the fingerprint sensor 330 in the fan out region 320, some or all of the traces 315 that couple the processing system 110 to the display region 305 pass through the fingerprint sensor 330. In one embodiment, the fingerprint sensor 330 defines a second sensing region in the input device 100 similar to the sensing region 120 described above.

For simplicity, only the traces 315 extending through the fingerprint sensor 330 are shown, but as described in more detail below, the fingerprint sensor 330 may have additional traces or electrodes as well as logic circuitry for detecting a fingerprint. The sensor module 204 uses the traces 315 to perform capacitive sensing in the fingerprint sensor 330. In one embodiment, before doing so, the sensor module 204 activates isolation logic 325 to disconnect a portion of the traces 315 in the fingerprint sensor 330 from a portion of the traces 315 in the display region 305 and sensing region 120. As such, the sensor module 204 may use only the portion of the traces 315 below the isolation logic 325 when detecting a fingerprint.

In one embodiment, the width of the integrated circuit forming the processing system 110 ranges from 18 to 30 millimeters. Assuming the fingerprint sensor 330 includes all of the traces 315, the width of the sensor 330 may be as wide as the integrated circuit, but this is not a requirement. Because the width of a typical finger may be 20 millimeter or less, the width of the fingerprint sensor 330 may be smaller than the width of the integrated circuit. In this example, the fingerprint sensor 330 may not use all of the traces in the fan out region 320 to detect a fingerprint.

In one embodiment, the height of the fingerprint sensor 330 (e.g., the up and down direction) is at least 2 millimeters and may range from 4 to 10 millimeters. In one embodiment, the height and width of the fingerprint sensor 330 is set so that the fingerprint can be detected without the user having to move the finger. Put differently, unlike a swipe fingerprint sensor where the user swipes the finger in a direction perpendicular to a row of sensors, the fingerprint sensor 330 can detect the ridges and valleys in a finger in a 2D area so that the finger can be stationary. To do so, the width and height dimensions of the fingerprint sensor 330 do not need to span across the entire fingerprint, but only a portion of the fingerprint can be detected. In another embodiment, the height or width of the fingerprint sensor 330 can be set even smaller, or the fingerprint sensor 330 can be made as a 1D or linear array, and the fingerprint sensor can be implemented as a swipe sensor.

In one embodiment, the processing system 110 and the fingerprint sensor 330 are disposed on a common substrate. For example, the common substrate may be an inner display substrate (e.g., TFT substrate). In another example, the processing system 110 and the fingerprint sensor 330 may be disposed on a cover plate (e.g., glass) that forms at least part of an outer surface of the input device 100 in FIG. 3. In one embodiment, the cover plate may be recessed at the location of the fingerprint sensor 330 to provide a tactile indication of the location of the sensor 330. For example, rather than providing a visual indication of the location of the fingerprint sensor 330 in the input device 100, the recessed portion of the cover plate can indicate to the user where she should place her finger so that her fingerprint is detected. In one embodiment, the cover plate may be etched or thinned to provide the tactile indication of the fingerprint sensor 330.

In another embodiment, the processing system 110 may be disposed on a different substrate than the substrate on which the traces 315 and fingerprint sensor 330 are disposed. For example, the integrated circuit or circuits of the processing system 110 may be disposed on a flexible PCB which includes contacts for routing the traces 315 to the processing system 110. The fan out region 320 may extend from where the traces 315 couple to the flexible PCB to the display region 305.

In one embodiment, the traces 315 are formed from a transparent conductive material such as indium tin oxide (ITO). Thus, if the traces 315 are disposed between the pixels in the display region 305 and an outside facing glass cover, the traces 315 do not occlude the image displayed by the pixels. Similarly, the sensor electrodes 310 may also be formed from a transparent material so as to not occlude the displayed image. However, the portion of the traces 315 in the fan out region 320 can be made from any conductive material since this portion of the traces 315 is outside of the active area of the display region 305 and thus cannot occlude a displayed image even if formed from a non-transparent conductive material.

When performing capacitive sensing in the sensing region 120 (which may occur in parallel with display updating or when display updating has been paused or stopped), the sensor module 204 can drive modulated signals onto the traces 315 and the sensor electrodes 310 and/or to receive resulting signals from the sensor electrodes 310 via the traces 315. The sensor module 204 can include transmitters and/or receivers (e.g., analog front ends (AFEs)) coupled to the traces 315 for transmitting and/or receiving the capacitive sensing signals. Using the capacitive sensing signals, the processing system 110 can determine a location of an input object in the sensing region 120.

To detect a fingerprint, the isolation logic 325 disconnects the bottom portion of the traces 315 from the top portion of the traces 315 that extends into the display region 305. Once disconnected, the sensor module 204 can use the same transmitter or receivers to perform capacitive sensing in the fingerprint sensor 330 using the bottom portion of the traces 315.

Although in FIG. 3 the traces 315 are coupled to the sensor electrodes 310 in order to perform capacitive sensing, in another embodiment, the traces 315 are coupled to display elements in the display region 305 rather than the sensor electrodes 310. For example, the traces 315 may be source lines, gate lines, or reference lines used when updating the pixels in the display region 305. However, when the traces 315 are not being used to update the pixels in the display region 305, the processing system 110 can activate the isolation logic 325 to disconnect the bottom portion of the traces 315 so that this portion of the traces 315 can perform capacitive sensing in the fingerprint sensor 330. When updating the display, the traces 315 may be coupled to a display driver module (e.g., display driver module 208 in FIG. 2) in the processing system 110, but when detecting a fingerprint, the traces 315 are coupled to the sensor module 204. In this manner, at least a portion of the traces 315 can be dual purposed for updating the display and performing capacitive sensing in non-overlapping time intervals.

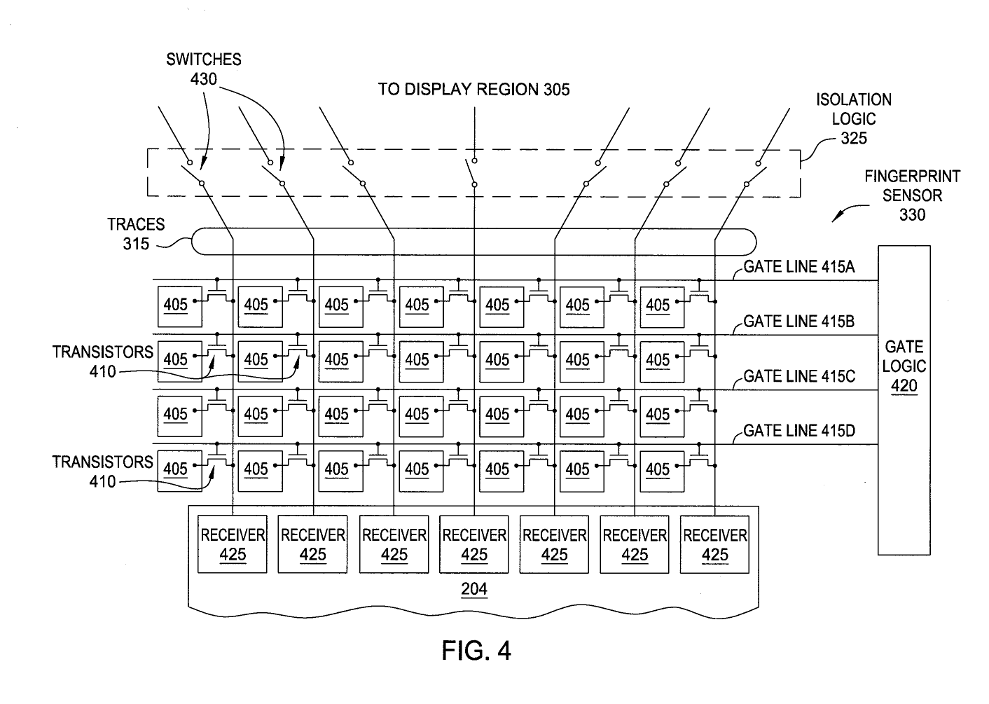

FIG. 4 illustrates a fingerprint sensor 330 that uses absolute capacitance for capacitance sensing in accordance with an embodiment of the invention. FIG. 4 illustrates only a portion of the input device 100 shown in FIG. 3. The display region 305 and some of the fan out region 320 are omitted from FIG. 4 so the details of the fingerprint sensor 330 can be seen.

The isolation logic 325 includes a plurality of switches 430 that selectively couples a first portion of the traces 315 extending through the fingerprint sensor 330 to a second portion of the traces 315 that extend through the remaining portion of the fan out region and into the display region. The switches 430 may include one or more transistors whose gates are controlled by the sensor module 204. To use the fingerprint sensor 330, the sensor module 204 opens the switches 430 thereby disconnecting the first portion of the traces 315 from the second portion.

The fingerprint sensor 330 includes four rows which correspond to the number of gate lines 415 and seven columns which correspond to the number of traces 315. Of course, when implemented, the fingerprint sensor 330 can include any number of traces 315 and gates lines 415.

The traces 315 are each selectively coupled to a plurality of sensor electrodes 405 in a column via transistors 410. The gates of the transistors 410 in each row are controlled by a respective one of the gate lines 415. Although transistors 410 are shown, the sensor electrodes 405 can be selectively coupled to the traces 315 using any type of switching circuitry. Moreover, if the electrodes 405 are wider than a column, the sensor electrodes 405 may be selectively coupled to multiple traces 315 which are driven to the same voltages.

The fingerprint sensor 330 also includes gate logic 420 which controls the gates lines 415. In one embodiment, the gate logic 420 drives a voltage on a gate line 415 in order to activate the transistors 410 in a single row. Put differently, the gate logic 420 controls the gate lines 415 such that only one row of the sensor electrodes 405 is coupled to the traces 315 at any given time. For example, the gate logic 420 may drive a first voltage on gate line 415A which activates all the transistors 410 in the first row while driving a second voltage on gate lines 415B-D which deactivates all the transistors 410 in rows two, three, and four. Thus, at this point in time, only the sensor electrodes 405 in the first row are coupled to the traces 315. At a different point of time, the gate logic 420 drives the first voltage on the gate line 415B while driving the second voltage on the gate lines 415A, 415C, and 415D. As a result, only the sensor electrodes 405 in the second row are coupled to the traces 315.

Each of the traces 315 is coupled to a respective receiver 425 in the sensor module 204. In one embodiment, the receivers 425 include an integrator for determining a capacitive measurement (e.g., a change in capacitance) for one of the sensor electrodes 405. For example, if the gate logic 420 has activated the gate line 415A, each of the receivers 425 determine a capacitive measurement for the sensor electrodes 405 in the first row of the fingerprint sensor 330. In one embodiment, the receivers 425 perform absolute capacitance sensing to determine the capacitive measurements. After determining capacitive measurements from the sensor electrodes 405 in each row, the processing system 110 can use the capacitive measurements to extract features from a finger (such as ridges and valleys, feature points, and the like) to identify a unique fingerprint.

Although shown as being non-overlapping, in one embodiment, the sensor electrodes 405 may overlap the traces 315 and/or the gates lines 415. In this scenario, the sensor electrodes 405 are disposed on a different layer in the fingerprint sensor 330 than the traces 315 and/or gates lines 415.

In one embodiment, the sensor electrodes 405 may have dimensions that are smaller than the dimensions of the sensor electrodes 310 in the sensing region 120 of FIG. 3. For example, in one embodiment, the sensor electrodes 405 have widths and heights that range from 15 to 50 microns, while the sensor electrodes 310 have widths and heights that range from 2-6 millimeters. Although shown as being rectangular, the sensor electrodes 405 may have any shape—e.g., circular, diamond, star, square, noncovex, convex, nonconcave, concave, etc. In one embodiment, the pitch between the sensor electrodes 405 ranges from 20 microns to 80 microns. In one embodiment, the sensor electrodes 405 may have dimensions and a pitch sufficient to result in a capacitive image with sufficient resolution (e.g., 100 dots per inch or greater) to detect ridges and valleys in a human finger.

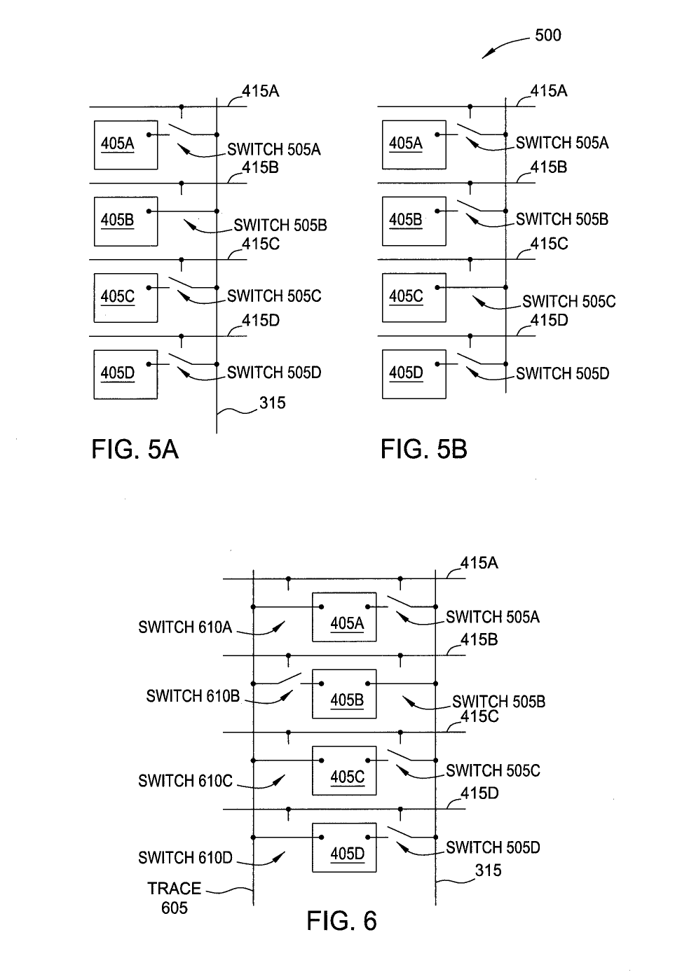

FIGS. 5A and 5B illustrate operating a portion of the fingerprint sensor 330 in accordance with an embodiment of the invention. FIGS. 5A and 5B illustrate one column 500 of the fingerprint sensor 330 shown in FIG. 4. The column 500 includes one of the traces 315 that is selectively coupled to four sensor electrodes 405 by switches 505 which may include the transistors 410 in FIG. 4. The switches 505 are controlled by the gate lines 415.

FIG. 5A illustrates a first time period where the gate line 415B closes switch 505B such that the sensor electrode 405B is electrically coupled to the trace 315. However, the gates lines 415A, 415C, and 415D keep the switches 505A, 505C, and 505D open such that the trace 315 is electrically disconnected from the sensor electrodes 405A, 405C, and 405D. As a result, the sensor electrodes 405A, 405C, and 405D are electrically floating. During this time period, the sensor (not shown) coupled to the trace 315 can perform capacitive sensing using the sensor electrode 405B.

FIG. 5B illustrates a second time period different than the first time period where the gate line 415C closes switch 505C such that the sensor electrode 405C is electrically coupled to the trace 315. That is, instead of the sensor electrode 405B being coupled to the trace 315 as shown in FIG. 5A, the sensor electrode 405C is coupled to the trace and can be used to perform capacitive sensing. In this manner, the sensor module rasters through the four sensor electrodes 405 which can form four capacitive sensing pixels.

FIG. 6 illustrates guarding unused electrodes in a fingerprint sensor in accordance with an embodiment of the invention. Like in FIGS. 5A and 5B, FIG. 6 illustrates one column 600 of a fingerprint sensor. Moreover, the column 600 includes the gates lines 415 which activate the switches 505 for selectively coupling the sensor electrodes 405 to the trace 315. Here, the gate line 415B has closed switch 505B to electrical couple the trace 315 to sensor electrode 405B. The other switches remain open, thereby insulating the remaining sensor electrodes 405A, 405C, and 405D from the trace 315.

The column 600 also includes a trace 605 which is selectively coupled to the sensor electrodes 405 via switches 610A-D. Like switches 505A-D, the switches 610A-D are controlled by the gate lines 415A-D. However, if the voltage on the gate lines 415 closes the switches 505, the same voltage opens the switches 610. That is, the voltage on the gate lines 415 ensure that either trace 315 or trace 605 is coupled to the sensor electrodes 405, but not both. In one embodiment, a first gate voltage closes the switches 505 but opens switches 610 while a second gate voltage closes the switches 610 but opens switches 505. For example, the switches 505 may be PMOS transistors while the switches 610 are NMOS transistors. Alternatively, the switches 505 and 610 may be the same type of transistor but the gate lines 415 may be coupled to the switches 610 via an inverter such that the opposite voltage is driven on the switches 610. Thus, if the voltage on the gate line 415 closes switch 505, the inverter applies the opposite voltage on switch 610, thereby opening the switch 610.

In FIG. 6, the gates lines 415A, 415C, and 415D open the switches 505A, 505C, and 505D but close the switches 610A, 610C, and 610D. As a result, the sensor electrodes 405A, 405C, and 405D are coupled to the trace 605 but not to the trace 315. In contrast, the gate line 415B closes the switch 505B and opens the switch 610B such that the sensor electrode 405B is coupled to trace 315 but not to the trace 605. The trace 315 can drive capacitive sensing signals on the sensor electrode 405B as described above.

Instead of permitting the other sensor electrodes to float, in FIG. 6, the fingerprint sensor can use trace 605 to drive a guarding signal onto the sensor electrodes 405A, 405C, and 405D. That is, the sensor electrodes 405 not currently being used to perform capacitive sensing can be guarded which may improve capacitive sensing. The guarding signal can be a DC voltage (e.g., Vcom) or a modulated signal. For example, the guarding signal may have the same frequency and phase as a modulated capacitive sensing signal that is driven onto the sensor electrode 405B.

In one embodiment, an input device has touch and display traces that are interleaved in the fan out region. Because fingerprint sensing can be performed when the display updating is paused or stopped, the display traces can be used to operate the fingerprint sensor. For example, the trace 605 may be a display trace (e.g., a source line or Vcom). As discussed above, the trace 315 may be dual purposed for performing capacitive sensing in a sensing region integrated into the display region as well as performing capacitive sensing in column 600 of a fingerprint sensor. When operating the fingerprint sensor, the trace 605 drives the unused sensor electrodes 405 to the guarding signal, but during display operating, is used by a display module in the processing system to update an image on the display. Although not shown, the trace 605 may also be coupled to the isolation logic 325 shown in FIG. 3 so that the portion of the trace 605 in the fingerprint sensor can be disconnected from the portion of the trace 605 in the display region.

Although FIG. 6 illustrates controlling the switches 505 and 610 in the same row using the same gate line, in another embodiment, the fingerprint sensor may include two gate lines for each row. One of the gate lines may control all the switches 505 in the row while the other gate line controls all the switches 610 in the row.

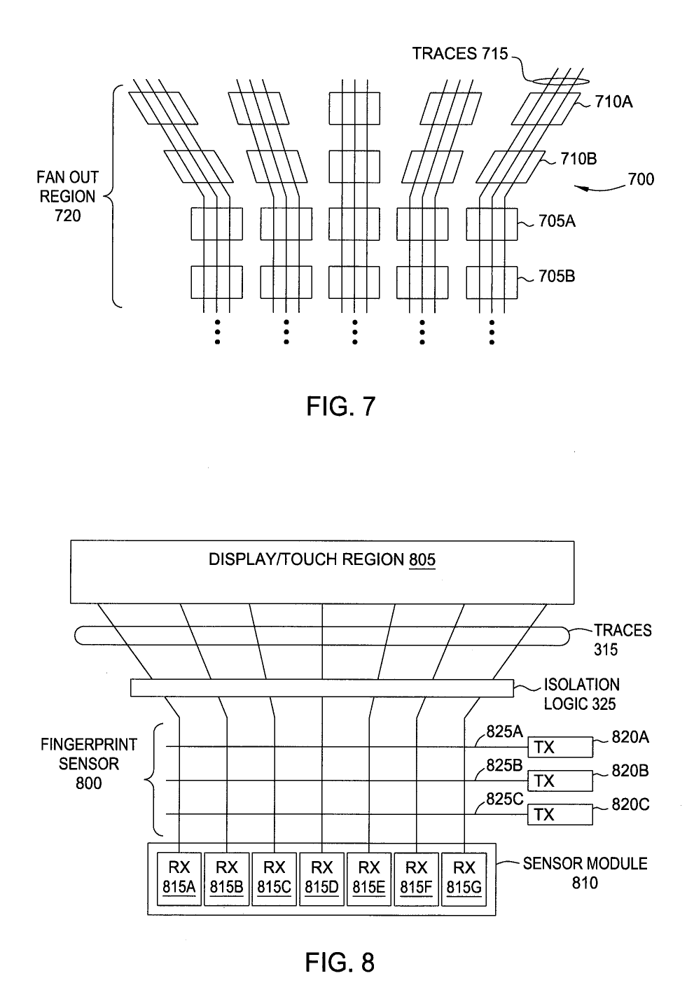

FIG. 7 illustrates a fingerprint sensor 700 that forms a trapezoidal shape in accordance with an embodiment of the invention. The fingerprint sensor 700 includes different shaped sensor electrodes depending on the routing paths of traces 715 in a fan out region 720. Like above, the fingerprint sensor 700 includes rectangular sensor electrode 705 in the portion of the fan out region 720 where the traces 715 extend parallel to each other. However, between the second and third rows in the fingerprint sensor 700, the traces 715 begin to fan out and extend in different directions such that the distance between at least some of the traces 715 increases.

In response, the shape of the sensor electrodes changes. That is, the sensor electrodes 710 in the upper two rows have a rhombus shape while the sensor electrodes 705 in the bottom two rows are rectangular. In one embodiment, the overall area of the sensor electrodes 710 may be different than the sensor electrodes 705. For example, the sensor electrodes 710 may have larger areas than the sensor electrodes 705. Moreover, the size of the sensor electrodes 710 may vary. For example, the sensor electrodes 710 in the same row may have different areas, and the sensor electrodes 710 in the first row may have different areas than the sensor electrodes 710 in the second row.

In addition, the pitch between the sensor electrodes 710 may be different than the pitch between the sensor electrodes 705. However, the sensor electrodes 710 may be arranged to ensure that the pitch provides sufficient resolution to detect ridges and valleys in a finger. For example, the sensor electrodes 710 may not extend into portions of the fan out region 720 where the sensor electrodes 710 would be too spread out (i.e., have too large of pitches) in order to couple to the traces 715 in an underlying layer.

In FIG. 7, the shapes of the sensor electrodes 710 change depending on the arrangement of the traces 715. However, in another embodiment, the shape of the sensor electrodes 710 may be the same as the shape of the sensor electrodes 705. Instead of changing the shape, the pitch of the sensor electrodes 710 may increase so that the sensor electrodes 710 can couple to the traces 715 in a different layer of the input device.

FIG. 8 illustrates a fingerprint sensor 800 that uses transcapacitive sensing in accordance with an embodiment of the invention. Like in FIG. 3, the traces 315 extend between a sensor module 810 in the processing system to a display/touch region 805. The sensor module 810 includes respective receivers 815 (RX) coupled to each of the traces 315. In one embodiment, the traces 315 are coupled to the receivers 815 when performing capacitive sensing (either in the fingerprint sensor 800 or in the display/touch region 805). However, if updating the display, the traces 315 may be coupled to a display module in the processing system. For example the traces 315 may be source lines or reference lines used to update display pixels in the display/touch region 805. In another embodiment, however, the traces 315 are used for capacitive sensing (and not display updating) in the display/touch region 805 and the fingerprint sensor 800.

The display/touch region 805 may be similar to the display region 305 and the sensing region 120 shown in FIG. 3. The display/touch region 805 may include sensor electrodes for performing capacitive sensing. Although in this example the fingerprint sensor 800 uses transcapacitive touch sensing, the sensor module 810 may use either transcapacitive touch sensing or absolute capacitive sensing to detect the location of an input object in the display/touch region 805. For example, the display/touch region 805 may include a rectangular array of sensor electrodes coupled to the traces 315 which are driven using absolute capacitance. Alternatively, the traces 315 may extend vertically through the display/touch region 805 while other traces extend horizontally through the display/touch region 805 and cross over the traces 315. The traces 315 may be receiver electrodes while the horizontal traces are transmitter electrodes, or vice versa.

FIG. 8 includes the isolation logic 325 so that the first portion of the traces 315 extending through the display/touch region 805 can be electrically insulated from the second portion of the traces 315 extending through the fingerprint sensor 800. Thus, when operating the fingerprint sensor 800, the isolation logic 325 ensures the receivers 815 receive signals only from the second portion of the traces 315.

The fingerprint sensor 800 includes transmitters (TX) 820 coupled to respective transmitter electrodes 825. Although the transmitters 820 are shown as being external to the sensor module 810, the transmitters 820 may be within the sensor module 810 or the processing system. The transmitters 820 transmit transmitter signals onto the transmitter electrodes 825 which cause resulting signals in the traces 315. The resulting signals are received by the receivers 815 and used by the processing system to identify a fingerprint as described above. Although in this example the traces 315 are the receiver electrodes, in another embodiment, the traces 315 may be coupled to transmitters and serve as the transmitter electrodes while the electrodes 825 may be coupled to receivers and serve as the receiver electrodes. In this embodiment, the isolation logic 325 may be omitted. In other words, the traces 315 in the fingerprint sensor 800 can remain coupled to the display/touch region 805 when operating the fingerprint sensor 800.

In one embodiment, the transmitters 820 may include receivers that permit the fingerprint sensor 800 to perform absolute capacitive sensing using the electrodes 825. Similarly, the fingerprint sensor 800 may perform absolute capacitive sensing using the receivers 815 and traces 315. In one embodiment, the fingerprint sensor 800 performs transcapacitive sensing during a first time period and performs absolute capacitive sensing during a second time period.

In one embodiment, the traces 315 may be disposed on a different layer in the fingerprint sensor 800 than the transmitter electrodes 825. The locations where the traces 315 overlap the transmitter electrodes 825 establish touch pixels for detecting changes in capacitance caused by ridges and valleys in a finger. In another example, the traces 315 and transmitter electrodes 825 may be disposed on the same layer but jumpers can be used so that the traces 315 and transmitter electrodes 825 do not directly contact each other.

Regardless whether the fingerprint sensor uses absolute capacitance (e.g., the fingerprint sensor 330 in FIG. 3) or transcapacitive sensing (e.g., the fingerprint sensor 800 in FIG. 8), the fingerprint sensor can also be used as a button or a movement detector. For example, in one mode of operation, instead of detecting a fingerprint, the fingerprint sensor may determine the presence of finger which then activates a corresponding function in the input device (e.g., opens an application or selects an item from a displayed GUI).

In another example, the fingerprint sensor can detect motion of an input object in another mode of operation. For example, the fingerprint sensor can detect when a user swipes her finger across the fingerprint sensor. The detected swipe can be used to perform a corresponding action in the input device such as scrolling a web browser or selecting different options in a menu. In another example, instead of swiping, a user may roll her finger in the fingerprint sensor either up, down, left, right, etc. from a default middle location. The detected roll of the finger can be used to, e.g., control a cursor in the display region. For example, rolling the finger up causes the cursor to move up, rolling the finger to the right moves the cursor to the right, and so forth. In this manner, the fingerprint sensor can be dual purposed in different mode of operation to detect the presence or movements of an input object in the sensing region of the fingerprint sensor. In another embodiment, the input device includes a capacitive button or a movement detector outside of the active region of the display (e.g., in the fan out region) as discussed above that does not detect a fingerprint. For example, the traces, switches, and sensor electrodes shown in FIGS. 3-8 can be used as a capacitive button or a movement detector regardless if the structure can also be used as a fingerprint sensor.

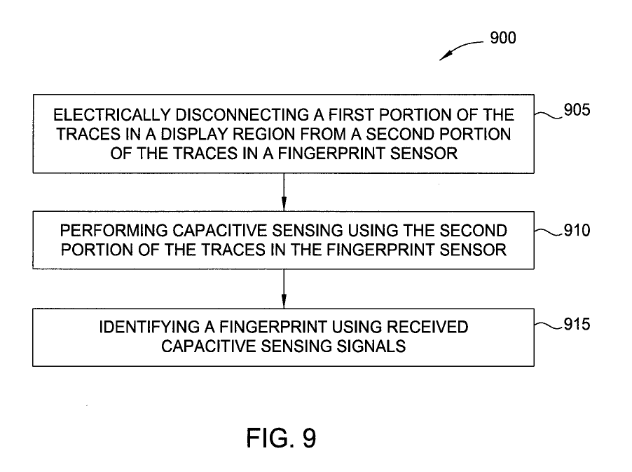

FIG. 9 illustrates a flowchart of a method 900 for operating a fingerprint sensor. At block 905, the input device electrically disconnects a first portion of the traces in a display region in the input device from a second portion of the traces in the fingerprint sensor. In one embodiment, the input device includes isolation circuitry (e.g., a plurality of transistors) that can selectively disconnect the portions of the traces. When operating the fingerprint sensor, the traces may be electrically separated into the two portions. However, when using the traces to perform capacitive sensing or display updating in the display region, the two portions of the traces are electrically coupled together.

At block 910, the input device performs capacitive sensing using the second portion of the traces in the fingerprint sensor. At block 915, the input device (e.g., the processing system or a software application) identifies a fingerprint using capacitive sensing signals received during block 910. The input device can use the second portion of the traces to perform transcapacitive or absolute capacitive sensing using the embodiments described above.

The embodiments and examples set forth herein were presented in order to best explain the embodiments in accordance with the present technology and its particular application and to thereby enable those skilled in the art to make and use the present technology. However, those skilled in the art will recognize that the foregoing description and examples have been presented for the purposes of illustration and example only. The description as set forth is not intended to be exhaustive or to limit the disclosure to the precise form disclosed.

In view of the foregoing, the scope of the present disclosure is determined by the claims that follow.

We calaim:

1. An input device comprising:
a display region configured to display an image;
a processing system;
a fan out region comprising a fingerprint sensor; and
a plurality of traces coupling the processing system to the display region, wherein the plurality of traces extend through the fingerprint sensor and the display region, wherein at least a portion of the fingerprint sensor is disposed in an area of the fan out region before the plurality of traces have fanned out,
wherein the fingerprint sensor is configured to perform capacitive sensing using the plurality of traces.

2. The input device of claim 1, further comprising:
isolation logic, wherein the fingerprint sensor is configured to perform capacitive sensing when the isolation logic electrically disconnects first portions of the plurality of traces extending through the display region from second portions of the plurality of traces extending through the fingerprint sensor, and wherein the fingerprint sensor is configured to perform capacitive sensing using the plurality of traces when display updating in the display region is paused.

3. The input device of claim 1, wherein the display region comprises a sensing region configured to perform capacitive sensing, wherein the processing system is configured to perform capacitive sensing in the sensing region using the plurality of traces at a different time than when the fingerprint sensor performs capacitive sensing using the plurality of traces.

4. The input device of claim 3, wherein each of the plurality of traces is coupled to a respective one of a plurality of sensor electrodes arranged in a rectangular array in the sensing region, wherein the processing system is configured to perform absolute capacitance sensing using the plurality of sensor electrodes.

5. The input device of claim 1, wherein the fingerprint sensor comprises:
gate electrodes extending in a direction perpendicular to the plurality of traces; and
gate logic configured to drive the gate electrodes so that a row in the fingerprint sensor is sensed.

6. The input device of claim 5, wherein the fingerprint sensor comprises:
a plurality of switches that selectively couple a plurality of sensor electrodes to a respective one of the plurality of traces, wherein each of the plurality of switches is controlled by one of the gate electrodes.

7. The input device of claim 6, wherein the plurality of sensor electrodes is arranged in rows and columns in the fingerprint sensor, wherein the gate logic is configured to control the gate electrodes such that only one row of the plurality of sensor electrodes is coupled to the plurality of traces at any given time.

8. The input device of claim 7, further comprising:
guard electrodes coupling the processing system to the display region, wherein the guard electrodes extend through the fingerprint sensor and the display region,
wherein the processing system is configured to drive a guarding signal onto the plurality of sensor electrodes in rows currently unused for capacitive sensing by the fingerprint sensor.

9. The input device of claim 6, wherein each of the plurality of sensor electrodes has a width and a height that ranges from 10 to 60 microns.

10. The input device of claim 6, wherein the plurality of sensor electrodes has a pitch that ranges from 20 to 80 microns.

11. The input device of claim 1, wherein the fingerprint sensor comprises:
a plurality of wires extending in a direction perpendicular to the plurality of traces, wherein the plurality of wires and the plurality of traces are coupled to transmitter and receivers for performing transcapacitive sensing.

12. The input device of claim 1, wherein the processing system is configured to use the plurality of traces to update the image in the display region when capacitive sensing in the fingerprint sensor is paused.

13. A processing system for performing capacitive sensing, the processing system comprising:
a sensor module comprising sensor circuitry configured to couple to a plurality of traces, wherein the plurality of traces extend through a fingerprint sensor in a fan out region to reach a display region,
wherein the sensor module is configured to:
control isolation logic to electrically disconnect first portions of the plurality of traces extending from the fingerprint sensor to the display region from second portions of the plurality of traces extending from the sensor module to the fingerprint sensor; and
perform capacitive sensing in the fingerprint sensor using the second portions of the plurality of traces when the second portions are disconnected from the first portions.

14. The processing system of claim 13, wherein the processing system comprises:
a display module for updating an image displayed in the display region, wherein the sensor module is configured to perform capacitive sensing using the plurality of traces when display updating in the display region is paused.

15. The processing system of claim 13, wherein the sensor module is configured to perform capacitive sensing in a sensing region in the display region using the plurality of traces at a different time than when the sensor module performs capacitive sensing in the fingerprint sensor.

16. The processing system of claim 13, wherein the sensor module is configured to perform absolute capacitive sensing using the second portions of the plurality of traces.

17. The processing system of claim 13, wherein the sensor module is configured to perform transcapacitive sensing using the second portions of the plurality of traces.

18. A method for performing capacitive sensing, the method comprising:
electrically disconnecting first portions of a plurality of traces extending from a processing system to a display region from second portions of the plurality of traces extending from a sensor module to a fingerprint sensor, wherein the plurality of traces couple the processing system to the display region via a fan out region, wherein the fan out region comprises the fingerprint sensor; and
performing capacitive sensing using the second portions of the plurality of traces in the fingerprint sensor when the first portions are disconnected from the second portions.

19. The method of claim 18, wherein capacitive sensing is performed when display updating is paused.

20. The method of claim 18, further comprising:
performing capacitive sensing in a sensing region within the display region using the plurality of traces, wherein capacitive sensing in the sensing region is performed at a different time than performing capacitive sensing using the second portions of the plurality of traces in the fingerprint sensor.
